(19) United States
(12) Patent Application Publication
(10) Pub. No.: US 2012/0268600 A1
(43) Pub. Date: Oct. 25, 2012

(54) METHODS FOR NOTIFYING A DRIVER OF A MOTOR VEHICLE ABOUT A DANGER SPOT AND DRIVER ASSISTANCE SYSTEMS USING SUCH METHODS

(75) Inventor: Oliver WAGNER, Gross-Gerau (DE)

(73) Assignee: GM GLOBAL TECHNOLOGY OPERATIONS LLC, Detroit, MI (US)

(21) Appl. No.: 13/449,372

(22) Filed: Apr. 18, 2012

(30) Foreign Application Priority Data
Apr. 19, 2011 (DE) 10 2011 018 157.1

(51) Int. Cl. H04N 7/18

(52) U.S. Cl. 348/148; 348/E07.085

(57) ABSTRACT

A method and a driver assistance system for notifying the driver of a motor vehicle about a danger spot are provided. In an embodiment, the method includes providing informational data about the danger spot from a data storage device, providing current image data using a camera, and analyzing a current danger situation by comparing the current image data with the informational data using a central processing unit. A warning signal is outputted to the driver via an output unit depending on the current danger situation.

### CROSS-REFERENCE TO RELATED APPLICATION

This application claims priority to German Patent Application No. 10 2011 018 157.1, filed Apr. 19, 2011, which is incorporated herein by reference in its entirety.

### TECHNICAL FIELD

The technical field generally relates to methods for supporting the driver of a vehicle at danger spots, in particular stops for special vehicles, for example public transportation vehicles, as well as to driver assistance systems for implementing the methods.

### BACKGROUND

There are numerous known devices for detecting traffic signs, in particular speed limit signs. Cameras are often used for detection. The traffic sign detection system is traditionally used to determine the maximum speed limit and warn the driver when the latter is being exceeded.

In addition, publication DE 20 2009 010 876 U1 discloses a system for warning road users about an increased danger of accidents at bus stops. It proposes that a bus be equipped with a transmitter, and a receiver be provided with a signal light a distance away from the stop. As the bus approaches the stop, the transmitter on the bus sends information to the receiver, as a function of which the signal lights can be activated to warn trailing traffic.

This system requires that each bus be equipped with a transmitter, and that each stop be equipped with a receiver and signal light. This makes it complicated and expensive.

It is at least one object to provide a more cost-effective method with which the driver of a motor vehicle is alerted early on about a danger spot, in particular a stop for public transportation vehicles. In addition, other objects, desirable features and characteristics will become apparent from the subsequent summary and detailed description, and the appended claims, taken in conjunction with the accompanying drawings and this background.

### SUMMARY

In this regard, a method for notifying the driver of a motor vehicle before a danger spot, in particular a stop for buses or trams, involves the following steps:

Providing informational data about a danger spot from a data storage device,
Acquiring current image data of the environment ahead by means of a camera,
Determining a current danger situation by comparing the current image data with the informational data by means of a central processing unit, and
Outputting a warning signal to the driver depending on the current danger situation via an output unit.

Since the environment ahead of the motor vehicle is acquired with the camera, the method allows predictive support for the driver. Depending on the range of the camera and the weather conditions, the driver can be provided with an early warning. His or her response time can be shortened as a result. The method thus makes it possible to better protect pedestrians at the danger spot against accidents.

The camera is preferably arranged in or on the motor vehicle, and pointed forward at the road and/or roadside, so that it can detect primarily traffic signs located on the roadside and persons standing on the roadside. Depending on the alignment and acquisition angle of the camera, several indications can be acquired at the danger spot, for example, the persons crossing the road, the course of the road, or the traffic density.

It is preferred that the camera for determining the current danger situation use the current image data of an image series. This makes it possible to compensate for obscured indications, for example, as a result of vehicles parking on the roadside or rain or fog, and ensure a high detection rate.

While a central processing unit compares the current image data with the informational data, the informational data and current image data are preferably present as digital data, thereby enabling a digital image evaluation that permits a very rapid evaluation with a high level of precision.

The informational data preferably encompass hazard indications, such as traffic sign data, in particular of a bus stop sign, a barricade sign, a stop sign, an intersection or a railway crossing. They preferably also encompass hazard indications such as road progression data, in particular for merging traffic, an intersection, or a bus bay. It is also preferred that the informational data encompass other hazard indications for typical dangers, in particular a traffic light or road inscription.

In an also preferred embodiment, the informational data encompass contour data for recognizing a special vehicle, in particular a bus and/or a tram.

It is preferred that the warning signal be output once a current danger situation has been identified and/or indicated, in particular the traffic sign and/or special vehicle.

It is preferred that the danger situation be weighted as a function of the comparison data acquired by comparing the current image data with the informational data. The response to the danger situation varies in severity depending on the hazard posed to persons in the danger situation.

In order to enable a weighting of the danger situation, another preferred embodiment provides that the informational data also encompass information for acquiring one or more of the following environmental data:

Special vehicle has arrived at the danger spot,
Persons on the roadside,
Persons crossing the road,
Magnitude of traffic density,
Weather conditions,
Distance from adjacent vehicles,
Road progression, and/or
Current speed of vehicle.

It is preferred that at least the warning signal differ as a function of the weighting, and/or that the vehicle be slowed down, and/or that the vehicle even be diverted.

It is especially preferred that a bus stop or railway stop, for example for a street car, be detected. In an especially preferred embodiment, the informational data encompass at least the traffic sign data for a stop for a special vehicle, in particular a bus or tram. In this embodiment, the informational data preferably encompass additional informational data at the stop and/or informational data for acquiring the bus or tram.

In addition, a driver assistance system that utilizes the above-described method is provided. The driver assistance system preferably encompasses a camera, a data storage device for storing informational data, a central processing unit for acquiring a danger situation, and an output unit for outputting a warning signal.

The warning signal is preferably an optical, acoustic and/or haptic signal, wherein the output unit is a light source, in particular an LED, a display, a loudspeaker and/or a steering wheel. However, it is also preferred that the warning signal be or encompass a control signal to an engine management system of a vehicle, which makes it possible to slow down and/or divert the vehicle.

The driver assistance program is preferably provided for acquiring a stop, in particular for buses or trams.

### DETAILED DESCRIPTION OF THE DRAWINGS

The embodiments will hereinafter be described in conjunction with the following drawing figures, wherein like numerals denote like elements, and wherein:

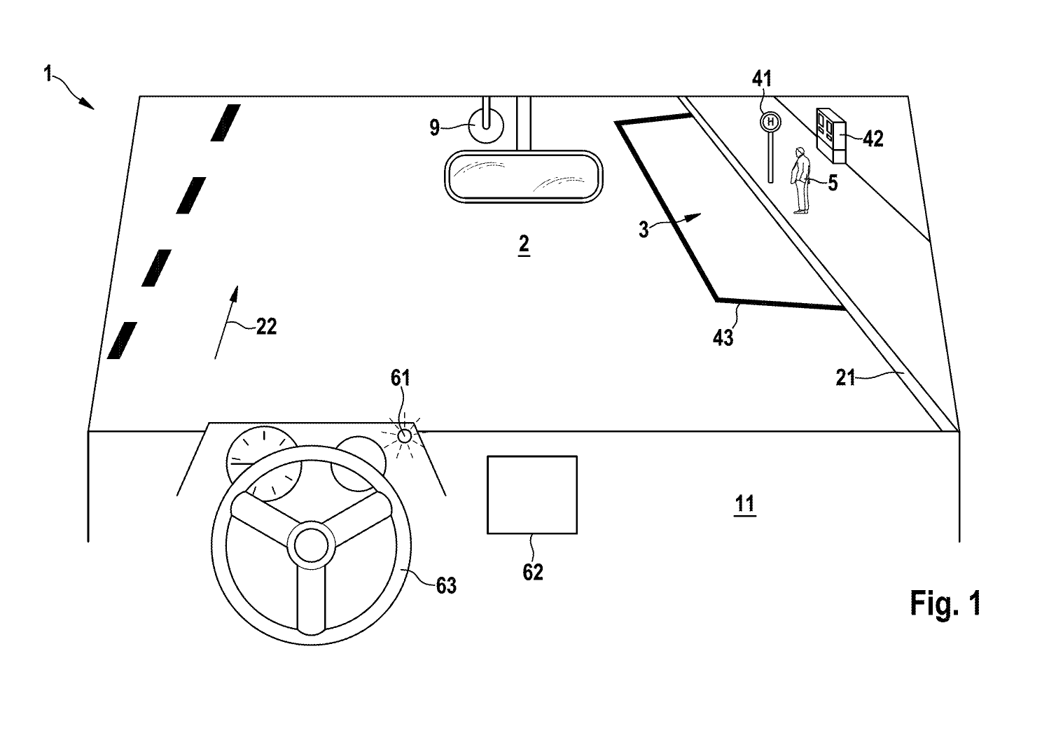

FIG. 1 shows a road as seen by the driver of a vehicle; and

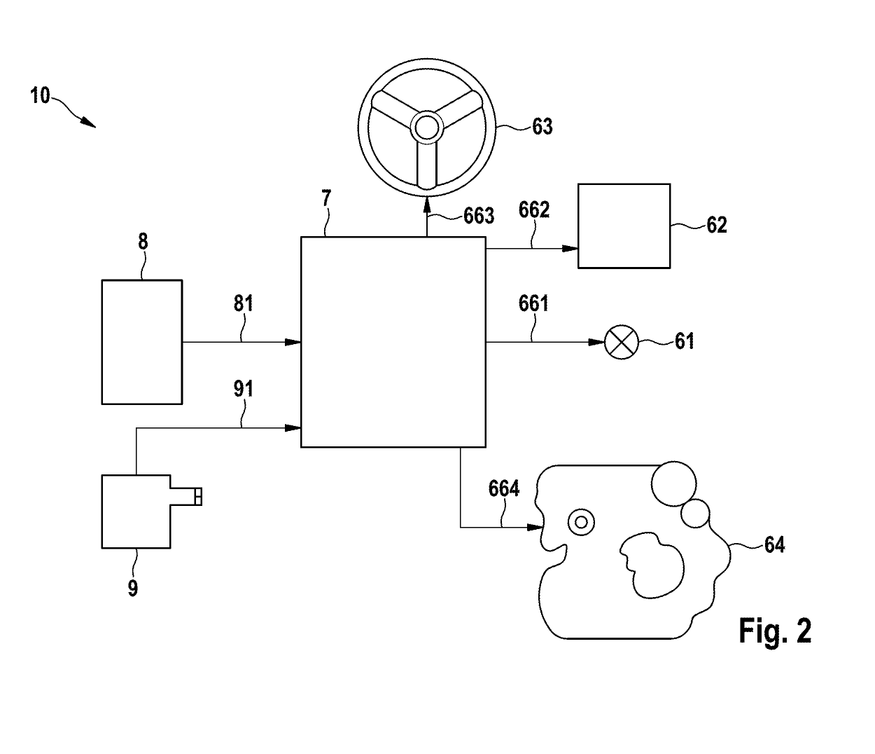

FIG. 2 shows a driver assistance system according to an exemplary embodiment.

### DETAILED DESCRIPTION

The following detailed description is merely exemplary in nature and is not intended to limit application and uses. Furthermore, there is no intention to be bound by any theory presented in the preceding background or summary or the following detailed description.

FIG. 1 shows a road 2 as seen by the driver of a vehicle 1. The vehicle exhibits a driver assistance system 10 according to an exemplary embodiment (see FIG. 2). The driver assistance system 10 encompasses an image processing unit, here a camera, which is arranged in a vehicle interior 11. The camera cyclically acquires current image data 91 (see FIG. 2) of the environment ahead of the vehicle 1 in the traveling direction 22, so as to recognize a danger situation at a danger spot 3 as early as possible.

FIG. 1 shows such a danger situation, in which the danger spot 3 is here a stop. The terms danger spot 3 and stop are used synonymously in the following.

The stop 3 is here characterized by a bus stop sign 41. In addition, a ticket machine 42 and road marking 43 of the stop 3 are provided.

A waiting person 5 is visible on a roadside 21 in the area of the stop 3.

Output units 61-63 (see also FIG. 2) are provided in a vehicle interior 11, which can be used to output a warning signal 661-663 (see also FIG. 2) in the danger situation. Depicted here as the output units are a light 61, a display 62 as well as a steering wheel 63 of the vehicle 1. The light 61 and display 62 can be used for optical warning signals 661, 662, and the steering wheel 63 for a haptic warning signal 663, for example by vibrating. A modified steering support in a preferred steering direction is further possible.

Alternatively or additionally, it is conceivable to use a loudspeaker (not shown) as an output unit for an acoustic warning signal. Given a danger situation involving a high hazard level, it is also further preferred that the vehicle be alternatively or additionally slowed down or diverted away from the danger by means of an engine management system 64 (see FIG. 2).

FIG. 2 shows the driver assistance system 10 according to an embodiment. The driver assistance system 20 encompasses a data storage device 8, which stores informational data 81 regarding the danger situation.

For example, such informational data 81 include hazard indications like traffic sign data that enable traffic sign detection. Primarily the traffic signs where a danger situation might exist, for example, a bus stop sign 41 (see FIG. 1), a closed sign, a stop sign, an intersection sign, a railway crossing sign or marking, or combinations thereof, are stored.

Other examples for informational data 81 include road progression data, which permit the recognition of a merge, a crossing, a curve or a bus bay, or other typical danger-related informational data 81, e.g., which allow recognition of a traffic light.

Informational data 81 can also include road markings 43 or road inscriptions, for example an inscription like “TAXI”, which enable the recognition of merges, bus stops or the like, such as merge signs and bus stop signs.

It is further preferred that contour data for recognizing a “special vehicle”, for example, a bus and/or tram, be used as informational data 81, which reflect the contour of such a vehicle and enable the recognition of the vehicle.

It is also conceivable to use the contour of a ticket machine 42 (see FIG. 1) for recognizing the bus stop 3.

The informational data preferably also encompass information with which environmental data relating to the danger situation can be acquired. For example, such environmental data make it possible to determined that:

a “special vehicle,” for example a bus or tram, but potentially a garbage truck or the like as well, has arrived at the danger spot 3,
one or more persons 5 are waiting on the roadside 21,
one or more persons 5 are crossing the road 2
and combinations thereof.

Such additional informational data also make it possible to acquire:

the magnitude of traffic density,
the distance and/or relative speed of the vehicle 1 in relation to adjacent vehicles,
the road progression,
the current speed of the vehicle 1, or
combinations thereof.

These additional informational data enable or improve a weighting of the danger situation, so that the warning signal 661-664 can be changed as a function of the weighting, i.e., the ascertained level of danger. The intensity and/or duration of the warning signal 661-664 is here varied depending on the weighting of the danger situation. In a danger situation that poses very little or no danger to third parties 5 and the vehicle 1, it is preferred that no warning signal 661-664 be output. Given a very acute danger situation, it is preferred that a continuous and strong, for example loud or bright, warning signal 661-664 be output, or that the vehicle 1 even be slowed down or diverted.

The driver assistance system 10 provides for a camera 9 for acquiring current image data, which acquires the environment ahead in the traveling direction 22. By comparing the informational data with the current image data, a danger situation is acquired when hazard indications are present. To this end, the driver assistance system 10 provides for a central processing unit 7. For example, a danger situation is present if a specific traffic sign was acquired, and/or if a bus stop was acquired, and/or if a special vehicle was acquired.

The central processing unit 7 is also provided for controlling the driver assistance system 10, and thus generates a warning signal 661-664 depending on the weighting of the danger situation.

For example, a steering wheel 63 is here provided as the output unit 61-64 for the warning signal 661-664, and enables a haptic warning by vibrating. In addition, for example, a light 61 and a display 62 for optical warnings are provided here. It is further provided that the warning signal 664 be transmitted to the engine management system 64, so as to even slow down the vehicle 1 or divert it from the danger.

In the exemplary embodiment on FIG. 1, the danger situation is primarily recognized based on the stop sign 41, but also based on the road machine 42 and road marking 43. The driver assistance system 10 according to an embodiment also recognizes a present hazard posed by a person 5 waiting on the roadside 21, and weights the danger situation accordingly. For example, the light 61 here outputs a warning light indicating the bus stop.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A method for notifying a driver of a motor vehicle about a danger spot, the method comprising the steps of:
providing informational data about the danger spot from a data storage device;
providing current image data using a camera;
analyzing a current danger situation by comparing the current image data with the informational data using a central processing unit; and
outputting a warning signal to the driver via an output unit depending on the current danger situation.

2. The method according to claim 1, wherein providing the informational data comprises providing the informational data chosen from traffic sign data, a closed sign, a stop sign, an intersection, a railway crossing, road progression data, a merge sign, a curve, a bus bay, a traffic light, road inscription, and combinations thereof.

3. The method according to claim 1, wherein providing the informational data comprises providing the informational data that encompass contour data for recognizing a “special vehicle”.

4. The method according to claim 1, wherein the warning signal is output once the current danger situation has been acquired.

5. The method according to claim 1, wherein providing the informational data comprises providing the informational data that further contains information for acquiring environmental data chosen from:
a “special vehicle” at the danger spot;
persons on a roadside;
persons crossing a road;
magnitude of traffic density;
weather conditions;
distance from adjacent vehicles;
road progression;
current speed of the motor vehicle; and
combinations thereof.

6. The method according to claim 1, wherein the current danger situation is weighted as a function of comparison data acquired by comparing the current image data with the informational data.

7. The method according to claim 1, wherein the warning signal changes as a function of weighting a danger situation, and/or as the motor vehicle is slowed down and/or diverted.

8. A driver assistance system for notifying a driver of a motor vehicle about a danger spot, the driver assistance system comprising:
a camera that acquires current image data of an environment ahead of the motor vehicle in a traveling direction;
a data storage device for storing informational data about the danger spot;
a central processing unit for comparing the current image data and the informational data and acquiring a danger situation; and
an output unit for outputting a warning signal based on the danger situation.

9. The driver assistance system according to claim 8, wherein the output unit is chosen from a light source, a display, a loudspeaker, a steering wheel and/or an engine management system, and wherein the warning signal is an optical, acoustic and/or haptic signal.

10. The driver assistance system according to claim 8, wherein the danger spot is a bus stop.

11. The driver assistance system according to claim 8, wherein the camera is configured to cyclically acquire the current image data.

12. The driver assistance system according to claim 8, wherein the informational data is chosen from traffic sign data, a closed sign, a stop sign, an intersection, a railway crossing, road progression data, a merge sign, a curve, a bus bay, a traffic light, road inscription, and combinations thereof.

13. The driver assistance system according to claim 8, wherein the informational data encompass contour data for recognizing a “special vehicle”.

14. The driver assistance system according to claim 8, wherein the informational data further contains information for acquiring environmental data chosen from:
a “special vehicle” at the danger spot;
persons on a roadside;
persons crossing a road;
magnitude of traffic density;
weather conditions;
distance from adjacent vehicles;
road progression;
current speed of the motor vehicle; and
combinations thereof.

15. The driver assistance system according to claim 8, wherein the output unit is provided in the interior of the motor vehicle.
